(19) United States
(12) Patent Application Publication
(10) Pub. No.: US 2010/0122080 A1
(43) Pub. Date: May 13, 2010

(54) PSEUDONYM CERTIFICATE PROCESS SYSTEM BY SPLITTING AUTHORITY

(75) Inventors: Sok Joon LEE, Daejeon (KR); Seung Wan HAN, Gwangju (KR); Yun Kyung LEE, Daejeon (KR); Byung Ho CHUNG, Daejeon (KR); Jeong Nyeo KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/614,961

(22) Filed: Nov. 9, 2009

(30) Foreign Application Priority Data
Nov. 11, 2008 (KR) 10-2008-0111782
Jul. 7, 2009 (KR) 10-2009-0061805

(51) Int. Cl. H04L 29/06

(52) U.S. Cl. 713/156; 726/4

(57) ABSTRACT

The present invention can't independently know real name information of a user unless a server of an authority treating real name certificate and a server of an authority treating pseudonym certificate collaborate mutually, so that privacy of a user isn't infringed. The present invention can acquire real name information of a user with collaboration of real name certification sever and pseudonym certification sever only if you need real name information for a user.

### CROSS-REFERENCE TO RELATED APPLICATION

This application claims priority from Korean Patent Application No. 10-2008-0111782, filed on Nov. 11, 2008 and Korean Patent Application No. 10-2009-0061805 filed on Jul. 7, 2009 in the Korean Intellectual Property Office, the disclosure of which is incorporated herein by reference in its entirety.

### BACKGROUND OF THE INVENTION

1. Field of the Invention

The present invention relates to pseudonym certificate process system by splitting authority, and more particularly, in which real name information of a user is confirmed only when real name certification server confers with an anonymity certification server, so that privacy of a user is not disclosed easily and the system can grasp real name information of a user only if necessary.

2. Description of the Related Art

An electronic certificate based on PKI (Public Key Infrastructure) is used for certification of a user in internet banking or financial transaction of a user. An only user having a secret key of an electronic certificate can sign rightly. An electronic certificate based on PKI is safe as there is very little probability that the other user who does not have a secret key forges an electronic signature.

The other side, an electronic certificate comprises real name information of a user, for example, a name, a social security number and other real name information identifying a user. Real name information of a user can disclosure when a user makes a financial transaction by real name information comprised in an electronic certificate, so a privacy of a user can be infringed.

An electronic certificate is generated when a user having need of an electronic certificate presents the user's real name information to real name certification server equipped in certification authority. Consequently, real name certification server can know all the real name information of a user from the time when a user creates electronic certificate, a user disclosures the user's real name information to real name certification server the time when a user creates an electronic certificate for a financial transaction.

The other side, any web service does not need real name information of a user.

For example, when a web service server provides adult information, a web service server has to confirm whether a user is a right user and age of a user is right age for using adult information. At this time, there is no need to use an electronic certificate which comprised real name information of a user. A pseudonym certificate is suggested for this problem. A pseudonym certificate suggested uses pseudonym or nickname instead of real name information comprised in an electronic certificate, for a user of an electronic certificate isn't identified.

But, when a certification server providing pseudonym certificate links up with real name information, eventually it is the same as a certification server knows real name information of a user.

A certification server linking up with real name information has the same right as server of real name certification authority. If an authority which can always analogize real name information of a user exists, real name information of anyone can be inquired and be traced by the authority at discretion, and privacy of the user can be disclosed.

### SUMMARY OF THE INVENTION

According to the present invention, there is provided an authority distributed pseudonym certificate process system, comprising real name certification server providing a one-time credit comprising a group private key and a part of a secrete key allotted to a user from the group private key to a terminal of a certified user and an anonymity certification server comparing a part of a secrete key acquired from a group signature submitted by the user and the part of the secrete key comprised in the one-time credit, certifying the user based on the result of the comparison, and issuing pseudonym certificate to the user, when the user submits the group signature, wherein the real name certification server determines real name information of the user only through the part of the secrete key provided by the anonymity certification server, so that an authority for confirming real name of the user is distributed.

The present invention provides pseudonym certificate process system by splitting authority, in which a server of an authority treating an electronic certificate can't grasp independently real name information of a user. The present invention can't independently know real name information of a user unless a server of an authority treating real name certificate and a server of an authority treating pseudonym certificate collaborate mutually, so that privacy of a user isn't infringed. The present invention can acquire real name information of a user with collaboration of real name certification sever and pseudonym certification sever only if you need real name information for a user.

### BRIEF DESCRIPTION OF THE DRAWINGS

The above and other features and advantages of the present invention will become more apparent by describing in detail preferred embodiments thereof with reference to the attached drawings in which:

FIG. 1 illustrates conceptually pseudonym certificate process system by splitting authority according to the present invention;

FIG. 2 illustrates conceptually a process that real name certification server grasps real name information of a user;

FIG. 3 illustrates a data structure of a one-time credit according to an exemplary embodiment of the present invention.

### DETAILED DESCRIPTION OF THE INVENTION

The present invention will hereinafter be described in detail with reference to the accompanying drawings in which exemplary embodiments of the invention are shown.

A general feature of the present invention is as the following. Pseudonym certificate process system by splitting authority according to the present invention comprises real name certification sever and an anonymity certification server. Pseudonym certification according to the present invention provides pseudonym certificate which doesn't comprise Ai to a user. Ai is defined in short group signature and is a part of gsk(short group signature is an article of D. boneh et al published in crypto '04)

When a user provides a one-time credit acquired from real name certification server and presents group signature, for an issue of pseudonym certificate, an anonymity certification server acquires Ai from group signature, compares the Ai acquired from the group signature and Ai of a group private key comprised in one-time credit, certifying the user based on the result of the comparison.

Accordingly, pseudonym certificate which an anonymity certification server provides to a user does not need to comprise Ai, pseudonym certificate which a user presents to a web service server does not comprise Ai, so that real name certification server can't independently grasp a real identity of a user. This is object that pseudonym certificate process system by splitting authority according to the present invention wants to embody, unless a user causes a particular problem, a specified server or organization can't grasp an identity of a user. But, when real name certification server and an anonymity certification server share a data and collaborate mutually, a user can be traced. In other words, any one of real name certification server, an anonymity certification server, and a service server can't independently trace real name of a user, simultaneously, if you need, real name of a user can be grasped.

A certification and using process of the present invention are as the following.

1) A user accesses to real name certification server and is certified and takes a one-time credit from the real name certification server.

2) A user submits a one-time credit acquired from real name certification server to an anonymity certification server. At this time, a user submits group signature with a submission of a one-time credit.

3) An anonymity certification server extracts Ai of a user from group signature.

4) An anonymity certification server compares extracted Ai and Ai written in a one-time certificate and certifies the user based on the result of the comparison.

5) An anonymity certification server issues pseudonym certificate to a user. At this time, pseudonym certificate doesn't comprise Ai.

6) A user submits pseudonym certificate to a web service server and uses various services which a web service server provides. At this time, a web service server knows pseudonym information of a user but doesn't know Ai, so can't know real name information of a user. Similarly, real name certification server can't know a user's Ai acting in a web service server. Hence, a real name certification server can't independently know real name information of a user.

Accordingly, when a user causes a problem while the user accesses to a web service server with using pseudonym certificate and uses a service provided by a web service server, a web service sever asks a trace of a user to an anonymity certification server, an anonymity certification server provides Ai comprised in the pseudonym certificate to real name certificate server. A real name certificate server determines a user using table which binds the Ai and real name information of a user.

In other words, real name certification server or an anonymity certification server can't infringe anonymity of a user. Associative relationship for real name information of a user and pseudonym information of a user can be determined only when real name certification server and pseudonym certification server collaborate mutually.

The present invention will hereinafter be described in detail with reference to the accompanying drawings.

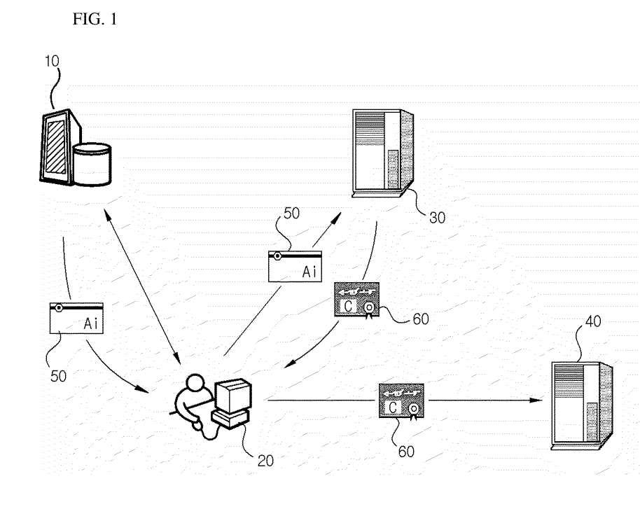

FIG. 1 illustrates conceptually pseudonym certificate process system by splitting authority according to the present invention.

The illustrated system includes real name certification server 10 and an anonymity certification server 30.

When a user provides real name information of a user (for example, a name of a user, a social security number, an address, a phone number, etc.) through a user's terminal 20, real name certification server 10 certifies the real name information and provides a one-time credit 50 to a user's terminal 20.

A one-time credit 50 is disused after used once to issue pseudonym certification 60, real name certification server 10 doesn't have any information explaining the relation between a one-time credit 50 and pseudonym certification 60.

In this time, a one-time credit 50 includes group private key information according to short group signature method. In this method, the group private key (gsk) of the i-th user has structure of gsk [i]=(Ai, Xi). At this point, i is changed according to the number of group members, real name certification server 10 makes only Ai corresponding to a user among information of a group private key comprised in a one-time credit 50.

A group private key is generated by a signature of a group manager and is provided to a member of a group, if it is proved that a user oneself is belonged to group, there is no need to open real name information of oneself.

After a one-time credit is provided to a user' terminal, a user presents a one-time credit 50 to pseudonym server 30, pseudonym server 30 generates pseudonym certificate 60 for a one-time credit 50 presented by a user and provides the pseudonym certificate generated to a user's terminal 20. At this point, pseudonym certificate 60 of a user doesn't comprise Ai.

An anonymity certification server 30 can decode Ai from a group signature presented by a user through a separate algorism.

But, A group private key decoded by pseudonym certification sever 30 is not the whole part of a group private key and is a part of it, an anonymity certification server doesn't have real name information of a user itself, hence an anonymity certification server 30 can't grasp a right real name information of a user with using a part of a group private key.

An anonymity certification server 30 determines the validity of a one-time credit 50 presented by a user's terminal 20 and provides pseudonym certificate 60 to a user, can't acquire real name information saved in real name certification server.

A user performs log-in with presenting pseudonym certificate 60 to a web service server 40.

When a user presents pseudonym certificate 60 to a web service server, a web service server 40 asks to an anonymity certification server 30 whether pseudonym certificate 60 presented by a user is valid.

When a web service server 40 asks validity, an anonymity certification server 30 determines whether a user presenting pseudonym certificate 60 is comprised in group private key gsk [i]=(Ai, Xi) and informs a result of the determination to a web service sever 40.

In a short group signature certification method, the validity of pseudonym certificate with group signature is determined according to whether Ai of a user is registered in group private key gsk [i]=(Ai, Xi). When pseudonym certificate of a user which a web service server 40 asks validity is comprised in a cancellation list of an anonymity certification server 30, namely, when Ai for a user isn't comprised in a group private key (gsk[i]), a web service server 40 rejects a certification through pseudonym certificate 60.

The other side, the present invention suggests that pseudonym certificate 60 comprises only pseudonym information instead of a group private key, but it is possible that pseudonym certificate 60 comprises characteristic information.

Characteristic information is any one of age of a user, a residence region, a sex and other thing showing a private feature of a user, even if you do not specify exactly, whether a user has a right for a use of service provided from a web service sever 40 can be determined.

For example, when a web service server 40 provides adult information, if information of only age comprised in pseudonym certificate is suitable for a use of service, a user can use the adult information provided a web service server 40. Naturally, a certification method using characteristic information can be applied for a financial transaction or other service which identification of a user is demanded.

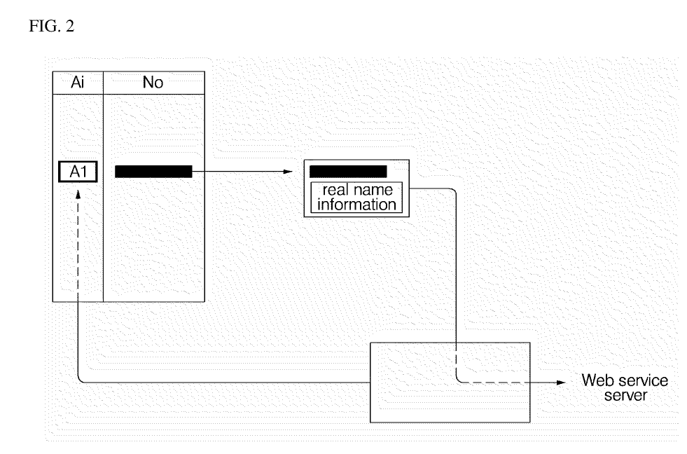

FIG. 2 illustrates conceptually a process that real name certification server 10 grasps real name information of a user.

In the present invention, real name certification sever 10 can't determine independently real name information of a user.

Pseudonym certificate 60 is issued by an anonymity certification server, doesn't comprise Ai, hence real name certification server 10 can't grasp an owner of pseudonym certificate 60 circulated in an on-line.

Similarly, an anonymity certification server 30 has only information for a part(Ai) of a group private key(gsk) in a one-time credit issued by real name certification server 10, directly doesn't change a data with real name certification server 10, so doesn't know real name information of a user.

When a web service sever 40 requests a trace for a user in a separation of real name certification server 10 and an anonymity certification server 30,

1) An anonymity certification server 30 extracts pseudonym information in pseudonym certificate of a user that a web service server 40 requests a trace,

2) An anonymity certification server 30 provides Ai for pseudonym information to real name certification sever 10,

3) Real name certification sever 10 inquires a table corresponding Ai and user's number and acquires real name information of a user based on a result of the inquiry.

Real name certification server 10 informs real name information of a user acquired through a process of the 3) to a web service server 40, so can provide real name information for a user.

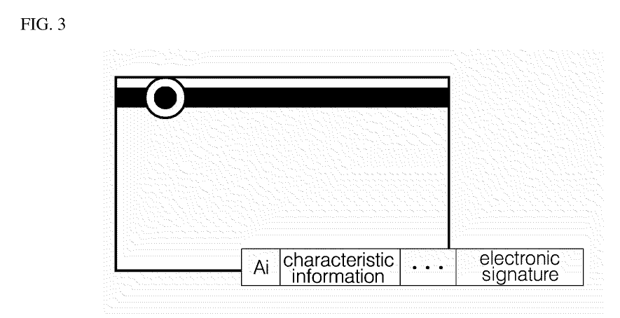

FIG. 3 illustrates a data structure of a one-time credit according to an exemplary embodiment of the present invention.

Referring to FIG. 3, a one-time credit 50 comprises Ai as a part of a group private key, characteristic information for a user, and an electronic signature provided by real name certification server 10. Ai comprised in a one-time credit 50 isn't comprised in pseudonym certificate 60 issued later by an anonymity certification server 30, is used in order to certify a user when a user presents a group signature to an anonymity certification server 30 for issue of pseudonym certificate. At this point, a one-time credit 50 can comprise characteristic information, or can't comprise characteristic information.

The characteristic information is information as sex of a user, age, an occupation, a residence region, shows only a personal feature of a user instead of a definite expression for a user.

In other words, characteristic information can be provided for a web service permitted according to sex to a web service server 40. Information for age is used in order to determine whether a user is an adult when a web service server 40 provides adult information. An occupation and a residence region can be used when a web service server 40 provides information for a special region or industry.

An anonymity certification server 30 makes pseudonym certificate 60 comprise characteristic information comprised in a one-time credit 50, or if user want, can provide an characteristic information certificate instead of pseudonym certificate 60 to a user. However, use of the characteristic information certificate can be restricted in a financial transaction among services provided by a web service server 40.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Pseudonym certificate process system by splitting authority, comprising:
real name certification server providing a one-time credit comprising a group private key and a part of a secrete key allotted to a user from the group private key to a terminal of a certified user; and
an anonymity certification server comparing a part of a secrete key acquired from a group signature submitted by the user and the part of the secrete key comprised in the one-time credit, certifying the user based on the result of the comparison, and issuing pseudonym certificate to the user, when the user submits the group signature;
wherein the real name certification server determines real name information of the user only through the part of the secrete key provided by the anonymity certification server,
so that an authority for confirming real name of the user is distributed.

2. The system of claim 1, wherein the one-time credit comprises characteristic information of the user.

3. The system of claim 2, wherein the characteristic information comprises of at least one of gender, age, occupation, and region information of the user.

4. The system of claim 2, wherein the one-time credit comprises an electronic signature of the real name certification server.

5. The system of claim 2, wherein the anonymity certification server determines permission of the user when the terminal of the user accesses to a web service server in reference to the characteristic information.

6. The system of claim 1, wherein the real name certification server comprises a table matching the part of the secrete key and user information for the user,
and determines real name information of the user in reference to the table when the anonymity certification server provides the part of the secrete key.

7. The system of claim 1, wherein the one-time credit comprises at least one of the group private key or characteristic information of the user, and electronic signature of the real name certification server.
